(19) United States
(12) Patent Application Publication
(10) Pub. No.: US 2014/0004323 A1
(43) Pub. Date: Jan. 2, 2014

(54) GLASS OR GLASS-CERAMIC PRODUCT WITH HIGH-TEMPERATURE RESISTANT LOW-ENERGY LAYER

(71) Applicants: Matthias Bockmeyer, Mainz (DE); Thorsten Damm, Nieder-Olm (DE); Andrea Anton, Hueffelsheim (DE); Inka Henze, Nieder-Olm (DE)

(72) Inventors: Matthias Bockmeyer, Mainz (DE); Thorsten Damm, Nieder-Olm (DE); Andrea Anton, Hueffelsheim (DE); Inka Henze, Nieder-Olm (DE)

(73) Assignee: Schott AG, Mainz (DE)

(21) Appl. No.: 13/884,866

(22) PCT Filed: Nov. 9, 2011
(86) PCT No.: PCT/EP11/05634

§ 371 Date: Jul. 24, 2013

(30) Foreign Application Priority Data
Nov. 10, 2010 (DE) 10 2010 050 771.7

(51) Int. Cl. C03C 17/25

(52) U.S. Cl. CPC C03C 17/25
USPC 428/206; 428/209; 427/380

(57) ABSTRACT

A product having a glass or glass-ceramic substrate is provided. The substrate is exposable to temperatures in a range of up to 700° C. and has, at least on one surface, a self-cleaning and/or dirt-repellent layer for improving cleanability. The layer is high-temperature resistant, as well as resistant to mechanical stresses. The layer includes at least one of the metal oxides of elements Hf, Y, Zr, or Ce in an at least partially nanocrystalline structure as a basic material, and at least one further metal cation of any of elements Ca, Ce, Y, K, Li, Mg, Sr, and Gd.

The invention relates to a product which comprises a glass or glass-ceramic substrate, the substrate being exposable to high temperatures in a range of up to 700° C. and being provided, at least on one surface thereof, with a self-cleaning and/or dirt-repellent, high-temperature resistant layer for improving cleanability.

It is generally known to provide the surfaces of substrates with self-cleaning or dirt-repellent layers. Likewise it is known to provide the surfaces of glass, glass-ceramic, ceramic or metal material with a dirt- and/or water-repellent layer in order to achieve improved cleanability.

Particular challenges as to functionality and durability of the layer arise when the substrates are exposed to elevated temperatures, such as in a range from 200° C. to above 350° C., and to substantial mechanical stresses. This is for instance the case when the substrate is a glass-ceramic substrate used as a cooktop.

The dirt-repellent effect of a layer may be created by producing a low surface energy. Layers of this kind are distinguished for example by a contact angle to water of about φ>90°, and therefore they are hydrophobic.

A low surface energy may be produced, for example, by organic fluorine layer systems. DE 10236728 and U.S. Pat. No. 5,726,247 disclose a liquid phase method, and U.S. Pat. No. 5,380,557 discloses a gas phase method for producing such layers. Layers produced in this manner may have a contact angle to water of about φ>90°, in particular also of φ>100°. As a result thereof, these layers have a polar fraction of the surface energy of less than 2 mN/m and a disperse fraction of less than 20 mN/m.

A disadvantage of layers based on organic systems is that they exhibit long-term heat-resistance only in a temperature range of up to a maximum of 350° C. Especially with organofluorine systems there is a risk of setting free harmful substances at temperatures of more than about 200° C.

Moreover, such layers are not resistant to mechanical wear, for example as a result of abrasion, which may lead to a formation of scratches or other surface damage.

By using the lotus effect, patterned layers may be created having superhydrophobic properties. These layers have contact angles to water of φ>100°. These systems do not exhibit sufficient mechanical strength either.

Therefore, these known layers have proved to be unsuitable for certain applications, for example if the substrate is permanently subjected to warm-up and cool-down cycles while being exposed to temperatures in a range of up to 400° C. or even to short-term peak temperatures of up to 700° C., which is the case for a glass-ceramic product used as a cooktop, for example.

A self-cleaning effect may also be created by thermocatalytically active layers. In this case the intensity of self-cleaning increases with increasing temperature and time, the cleaning effect ultimately being based on an oxidative decomposition of the contamination. For example, DE 10 2008 039684 discloses a thermocatalytically effective coating based on lithium compounds.

A drawback thereof is that the effect of oxidative decomposition only starts at temperatures from about 350° C. to 400° C., and only after a comparatively long retention time of about 1 h. These inorganic layers may be quite stable mechanically and may exhibit a relatively high thermal stability. However, such layers, especially inorganic oxide material systems are typically not hydrophobic or even superhydrophobic. For example, ZrO₂ has a contact angle to water of about φ=50°, and thus exhibits only a slight dirt-repellent effect.

Hence, layers which are both mechanically stable and high-temperature resistant and moreover have hydrophobic properties are not known.

The inventors have identified these drawbacks and have set themselves the task of developing a layer which is highly heat-resistant and at the same time also long-term resistant to external wear such as scratches or furrows, and which is distinguished by a significantly better cleanability.

The contaminations which are organic contaminants should be removable easily and safely both at room temperature and after baking at temperatures of about 250° C. or of 350° C. In particular, typical food contaminations such as by cottage cheese, ketchup, processed cheese, soy sauce, salad oil, or a mixture of egg and soy sauce should be removable easily.

The cleanability may be tested, for example, with a contamination by 30 ml of a 3.5 percent milk on the coated substrate, heating to 400° C. and a holding time of 30 minutes, with four repetitions.

The cleanability may also be tested, for example, with a contamination by 2 g of a mixture of 50 mass % soy sauce and 50 mass % sunflower oil on the coated substrate, heating to 230° C. and a holding time of 30 minutes, with four repetitions. Cleaning is done merely by soaking with water and by mechanical wiping using a wet sponge.

Desirably, the layer according to the invention should be highly heat-resistant in a temperature range around 400° C. and to peak temperatures in a range of up to 700° C., furthermore the layer according to one embodiment of the invention should exhibit a high thermal shock resistance for temperatures in a range of up to 400° C.

Page 4 of 26

The layer must not impose any substantial changes to the geometry of the substrate, in particular flatness in case of a planar substrate such as a glass-ceramic cooktop should be maintained.

Mechanical wear resistance such as to abrasion should be at least as effective as in the methods mentioned above, i.e. the enhanced temperature stability and cleanability of the layer according to the invention should not have any adverse effects in terms of mechanical strength.

Ideally, the properties of the layer according to the invention should preferably be retained throughout a product life of 10 years.

According to still another embodiment of the invention, the layer should have a radiation transmittance of at least 45%. And, the layer should not change the visual appearance of the substrate, that is to say it should be colorless and optically transparent.

In one particular embodiment according to the invention, however, a visual change in the appearance of the substrate is desired to allow for a noticeable visual distinction of the substrate treated with the layer as compared to an untreated substrate.

The layer should not undergo any change in adhesive strength before or after temperature stresses, the adhesive strength

Page 5 of 26 may be checked with a tape test according to DIN 58196 T6 with severity level K2, before and after exposure to heat.

Moreover, the layer should be chemically resistant to chemical detergents commonly used, such as e.g. Sidol® CERAN® cleaner, both when applied at room temperature as well as after baking at 250° C. and a 4 hours dwell time.

According to the invention, these objects are achieved by a product comprising a glass or glass-ceramic substrate which is at least partially provided with an inorganic layer having a surface which forms at least a portion of the outer surface of the product and including a metal oxide, wherein the layer has an at least partially nanocrystalline structure and comprises at least one of the metal oxides of elements Hf, Y, Zr, or Ce as a basic material, wherein the metal oxide layer comprises at least one further metal cation of any of the elements Ca, Ce, Y, K, Li, Mg, Sr, or Gd, and due to the at least one further metal cation provides a thermo-catalytic function.

Surprisingly, it has been found that the layer according to the invention which comprises an at least partially nanocrystalline inorganic structure and contains at least one of the metal oxides ZrO₂, CeO₂, HfO₂, or Y₂O₃ as a basic material, has a low-energy surface.

Additionally, as indicated above, the layer according to the invention is doped with or has admixed thermocatalytically active cations. Cations that may be incorporated into the layer include, for example, Ca, Ce, Y, K, Li, Mg, Sr, and Gd. The doping or admixture may be effected to an amount of up to 50 mol %. Surprisingly, even when the basic layer is doped with or has admixed other oxides, it maintains its low surface energy.

The inorganic layer of the invention thus has both hydrophobic and thermocatalytic properties, with the thermocatalytic effects already occurring at temperatures of about 325° C.

The layers according to the invention have a low surface energy, for example with a polar fraction of <10 mN/m, in particular <5 mN/m, and with a disperse fraction of <35 mN/m, in particular <30 mN/m. This effect results in a contact angle to water of φ>80°, in particular of φ>85°, whereby the layer has dirt-repellent effects.

The doping with thermocatalytically active cations furthermore implies the effect of oxidative decomposition of the contaminants and thus results in an improved cleanability already at temperatures in a range around 325° C.

The so produced layer is distinguished by a high resistance to mechanical wear such as abrasion. In one embodiment of the invention, this is achieved by a low residual porosity in a range of less than 25, preferably less than 20, and more preferably less than 15 percent by volume.

Typical pore geometries include meso- or micropores having an average pore diameter in a range of less than 10 nm, preferably less than 5 nm, and more preferably less than 3 nm, typically of bottleneck-shaped geometry.

In one particular embodiment of the invention the layers include a certain proportion of closed pores or pores that are not accessible for water. This proportion of the total number of pores may vary between 0 and 100%.

The layers preferably have a refractive index in a range from 1.7 to 2.2, more preferably from 1.8 to 2.1.

The surface roughness of the layers is in a range of less than 10 nm, preferably less than 5 nm, and more preferably less than 2 nm. This property impedes the adhesion of contaminants.

The thickness of the layer according to the invention on the substrate is preferably up to 80 nm, in order to achieve a visually inconspicuous effect. This ensures that layer thickness variations are not perceived as disturbing interference effects. The minimum thickness of the layer is 5 nm.

Another result thereof is that potential damage to the surface due to mechanical abrasion, for example scratches, will be much less noticeable than on an untreated surface. Therefore, in one particular embodiment the layer of the invention additionally has a scratch protection function as compared to uncoated surfaces.

The layer may be produced such as to be highly transparent. The layer may exhibit a transmittance in a range of more than 80%, preferably of more than 85%, and more preferably of more than 88% for electromagnetic radiation in a range of wavelengths from 380 nm to 780 nm. As a result thereof the coating is typically optically hardly noticeable. In the infrared, in particular around the radiation maximum of thermal radiators, the layer may have a transmittance of more than 45% as well.

The basic material of the layer preferably comprises ZrO₂ or CeO₂. Preferably, the material is in nanocrystalline form having a crystallite size in a range from 4 to 50 nm, a granular structure in which the nanocrystals are arranged without any preferred orientation being especially preferred.

In case of ZrO₂-containing layers, the layer preferably includes a fraction of HfO₂, with a mass proportion relative to the ZrO₂ of less than 5 mass %, preferably less than 2 mass %, more preferably less than 1 mass %.

In one particular embodiment, portions of the structure may also contain amorphous fractions of the metal oxides. The nanocrystalline fraction in the layer is greater than 25 percent by volume, more preferably greater than 50 percent by volume, most preferably greater than 75 percent by volume.

The ZrO₂ may have a monoclinic, preferably tetragonal or cubic crystal form. The CeO₂ may have a monoclinic or preferably tetragonal crystal form.

In one particular embodiment, the thermocatalytically active cation is incorporated into the crystal lattice of the at least partially nanocrystalline material. Therefore, the thermocatalytically active metal oxide does not form an own crystalline phase.

In one particular embodiment of the invention, the basic material may comprise pyrochlores of Zr, such as Ce₂Zr₂O₇, La₂Zr₂O₇, Gd₂Zr₂O₇, or Y₂Zr₂O₇. Layers including these specific crystallites are distinguished by a very high temperature resistance, long-term durability, and low surface energy.

Furthermore, the metal oxide layer may include Si, Al, Na, Li, Sr, B, P, Sb, Ti, F, MgF₂, or CaF₂.

In another embodiment of the invention, the layer additionally includes inorganic amorphous or crystalline nanoparticles, oxidic nanoparticles having a mean diameter from 4 to 30 nm being preferably used. These nanoparticles help to improve abrasion resistance and/or to reduce porosity, inter alia.

In one particular embodiment, doping the layer with specific cations or forming the layer as a mixed oxide layer may result in a stress relief in the layer. Because of this property, it is also possible to apply a plurality of layers onto the substrate, one above the other.

In another specific embodiment, the low-energy oxide is embedded in a glassy matrix. As a result thereof, an advantage of the present invention is that a glass-ceramic-like layer is formed exhibiting an expansion of approximately zero. This allows to avoid stresses at the interface between the layer and the substrate or between different layers. This embodiment of the invention is particularly suitable for coating glass-ceramic substrates such as those used for high-temperature applications, for example for cooktops, and also exhibiting a near zero thermal expansion within a certain temperature range.

The layer may be applied to substrates such as glass or a glass-ceramic, wherein the substrates may be transparent, semi-transparent, or non-transparent, as well. In particular it is possible for the metal oxide layer to be applied to substrates that are entirely or partially provided with decorative layers, semi-transparent layers, barrier layers, adhesion promoting layers, or functional layers, such as electrically conductive layers, thermochromic, electrochromic, or magnetochromic layers.

In one specific embodiment of the invention, the layer may be applied to a mixed layer including a plurality of oxides, for example TiO₂ and SiO₂, or ZrO₂ and SiO₂. This layer preferably has a refractive index from 1.65 to 1.8 and a layer thickness ranging from 20 nm to 150 nm.

A function of this mixed layer is to minimize visual conspicuousness of the layer, since due to its refractive index it has a comparably high reflectance as compared to an uncoated substrate.

Furthermore, the substrates may comprise materials such as sintered glass, sintered glass-ceramic, ceramics, metal, enamel, or plastics.

According to another specific embodiment of the invention, the layer is applied to a glass-ceramic substrate, preferably a transparent glass-ceramic which has a glassy zone as is known in the art, with a thickness ranging from 50 nm to 10 μm, preferably from 200 nm to 2000 nm.

A glass-ceramic substrate suitable for the invention may comprise the elements Si, O, Na, Al, Zr, K, Ca, Ti, Mg, Nb, B, Sr, La, Li, inter alia.

The products comprising the entirely or partially coated substrate may be used as a component in or on devices for cooking, frying, baking, or grilling, as well as microwave devices and deep fat frying devices. Moreover, these products may be used on or in baking sheets and molds, on or in cooking utensils, for furnace lining, as a viewing window, or for interior trim.

The products of the invention may also be used as a component in or on heat generating devices such as fireplaces, wood-burning stoves, heating systems, radiant heaters, exhaust gas and exhaust air systems, as a viewing window or for interior trim, in particular also as a viewing window of a heating unit.

According to one possible embodiment, the layer is applied to the substrate using liquid phase deposition processes such as a sol-gel process, e.g. by roll coating, pad printing processes, spray coating, or preferably using screen printing processes.

According to another embodiment, the layer is applied using a gas phase coating process such as sputtering or APCVD (atmospheric pressure CVD), a pulsed mid-frequency sputtering process being preferred.

In another embodiment, a further layer is provided below the layer of the invention, which further layer is an adhesion promoting layer comprising SiO₂ or a mixed oxide, for example. This layer may also be produced by a liquid phase process, or by segregation from the substrate, if the substrate is a glass-ceramic substrate. Furthermore, the adhesion promoting layer may also be applied using CVD, or by flame pyrolysis.

Exemplary embodiments of manufacturing a high-temperature resistant low-energy layer according to the invention will now be described below.

According to one embodiment, the layer is applied onto the substrate using a liquid phase deposition process. As a precursor of the coating, metal salts of Ca, Gd, Li, Y, Zr, Hf, Ce, Mg, K, Ti, Al, or La may be used, for example as chlorides and/or nitrates and/or sulfates, furthermore also acetates and/or propionates and/or acetylacetonates and/or derivatives of polyether carboxylic acid.

Furthermore, classical sol-gel precursors based on alcoholates of Hf, Zr, Ti, Si, Al, Mg, Ce, or Y may be used. For stabilizing the alcoholates, organic ligands coordinating to the metal cation may be used, in particular chelating ligands.

For example, these may include ligands such as acetate, propionate, formate, ethoxyacetate, methoxy-ethoxy-acetate, methoxy-ethoxy-ethoxy-acetate, ethyl acetoacetate, acetylacetone, ethanolamine, diethanolamine, triethanolamine, 1,3-propanediol, 1,5-pentanediol, methoxypropanol, isopropoxyethanol.

Furthermore, hybrid polymeric sol-gel precursors with organic crosslinkable substituents functionalized with methacrylate groups or epoxide groups, for example, may also be used.

In specific embodiments of the invention, amorphous sol-gel precursor powders are used for the synthesis of Ti- and/or Al- and/or Hf- and/or Zr- and/or Ce-containing sol-gel precursors. These are obtained, for example, by reacting 1 mol of zirconium tetrapropylate with 1 mol of acetylacetone, followed by condensation with 3 mol of H₂O and removal of the volatile constituents by means of a rotary evaporator. The hydrolysis and condensation reactions may be carried out either in an acidic as well as in a basic environment.

Solvents that are preferably used for screen printable coating solutions include solvents having a vapor pressure of less than 10 bar, more preferably less than 5 bar, and most preferably less than 1 bar. These may for example include combinations of water, n-butanol, diethylene glycol monoethyl ether, tripropylene glycol monomethyl ether, terpineol, n-butyl acetate.

In order to permit adjustment of the desired viscosity, appropriate organic and inorganic additives are used. Organic additives may include, for example, hydroxyethyl cellulose and/or hydroxypropyl cellulose and/or xanthan gum and/or polyvinyl alcohol and/or polyethylene alcohol and/or polyethylene glycol, block copolymers and/or triblock copolymers and/or tree resins and/or polyacrylates and/or polymethacrylates.

For pasting, polysiloxanes and silicone resins may be used, and according to a particular embodiment inorganic nanoparticles may be used as well. According to the invention, the viscosities typically range from 1 to 10,000 mPa·s, preferably from 10 to 5,000 mPa·s, and more preferably from 100 to 2,000 mPa·s.

Examples for producing the coating solution according to the invention:

### EXAMPLE 1

For producing a coating solution according to the invention, 4 g of a 53 mass % (CaO*0.08, ZrO₂*0.92) precursor powder is dissolved in diethylene glycol monoethyl ether, mixed with 10 g of triethanolamine and 4 g of a pasting agent. By screen printing, layers are applied having a wet film thickness in a range from 2 to 4 μm, which shrinks to a xerogel film thickness after drying at 200° C., to a layer thickness of 200 to 400 nm.

After heat treatment of the layers at 500° C. for a period of 1 h, layers according to the invention are obtained which after 2 days exhibit a contact angle to water of φ>80°. The thickness of the layers ranges from 30 to 60 nm.

After burning-in food (250° C., 350° C.), i.e. soy sauce, ketchup, processed cheese, and cottage cheese, these layers exhibit a much better cleanability than a similar uncoated surface. Cleaning was first carried out using water, then with detergent-containing water, then with ethanol, and then using a razor blade.

### EXAMPLE 2

For producing a coating solution according to the invention, 4 g of a 57 mass % (Y₂O₃*0.08, ZrO₂*0.92) precursor powder is dissolved in water, mixed with 10 g of triethanolamine and 4 g of a pasting agent. By screen printing, layers are applied having a wet film thickness in a range from 2 to 4 μm, which shrinks to a xerogel film thickness after drying at 200° C., to a layer thickness of 200 to 400 nm.

After heat treatment of the layers at about 500° C. for a period of 1 h, layers according to the invention are obtained which after 2 days exhibit a contact angle to water of φ>80°. The thickness of the layers ranges from 30 to 60 nm.

### EXAMPLE 3

For producing a coating solution according to the invention, 4 g of a 58 mass % (CeO₂*0.30, ZrO₂*0.70) precursor powder is dissolved in n-butanol, mixed with 10 g of triethanolamine and 4 g of a pasting agent. By screen printing, layers are applied having a wet film thickness in a range from 2 to 4 μm, which shrinks to a xerogel film thickness after drying at 200° C., to a layer thickness of 200 to 400 nm.

After heat treatment of the layers at about 500° C. for a period of 1 h, layers according to the invention are obtained which after 2 days exhibit a contact angle to water of φ>80°. The thickness of the layers ranges from 30 to 60 nm.

Method for producing the metal oxide layer according to the invention:

The exemplary embodiment relates to a ZrO₂ layer doped with Ca produced by a gas phase process in an inline sputter system.

The substrate is transferred via a lock chamber into a heating chamber, where it remains for a defined period of time to achieve a defined temperature. The heating chamber may be provided either separately or as a part of the coating chamber.

Subsequently, coating of the substrate is accomplished using a sputtering technique, a pulsed sputtering technique (MF sputtering) being a preferred choice, for reasons of process stability. In the simplest case, only ZrO₂ is deposited. It is also possible to deposit a multi-layer coating system, consisting of an adhesion promoting layer and/or a barrier layer and/or an anti-reflection layer.

To obtain a particularly dense layer of high strength, the power density for sputtering the ZrO₂ should be greater than 2 W/cm², preferably greater than 10 W/cm² and most preferably greater than 20 W/cm². The pressure for magnetron sputtering when using Ar sputtering gas ranges from 1*10⁻⁴ to 1*10⁻² mbar.

Application examples of the invention will now be described in more detail with reference to the accompanying figures.

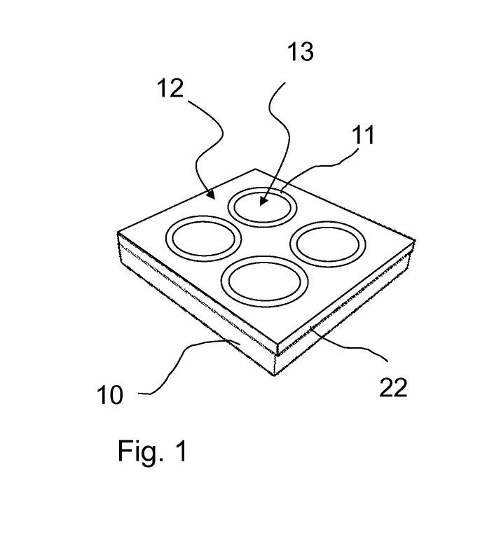

FIG. 1 shows a glass-ceramic substrate 10 which can be used as a cooktop and which is provided with decorative layers 11 for identifying cooking zones 13. An inorganic layer 22 according to the invention is applied on the utilization side 12. The layer according to the invention is applied onto decorative layers 11 and forms a part of the outer surface of the product. Here, the preferably optically inconspicuous layer 22 also extends over the cooking zones.

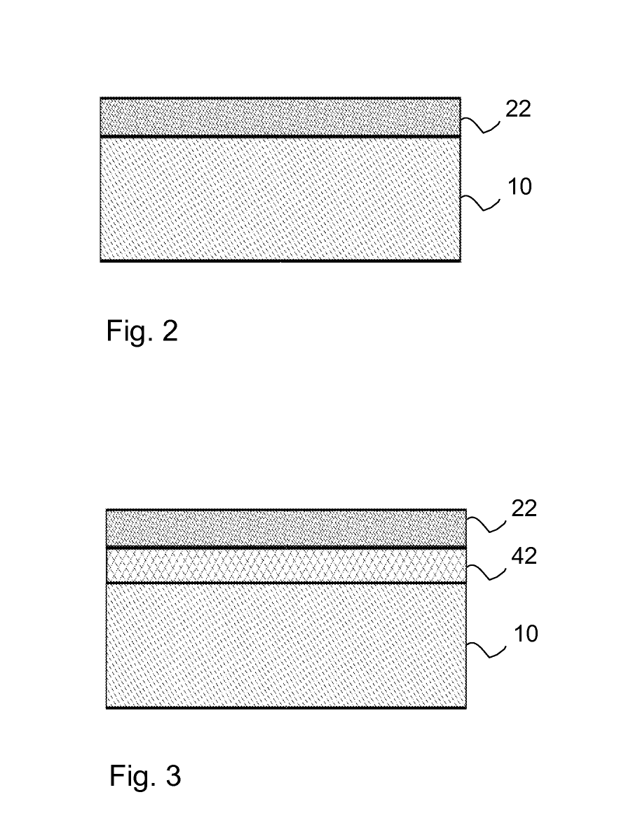

FIG. 2 shows a cross section through a glass-ceramic substrate 10 according to the invention coated with an inorganic layer 22.

FIG. 3 shows a variation of the embodiment shown in FIG. 2. In the embodiment of FIG. 3, the inorganic layer 22 according to the invention is not directly deposited on glass-ceramic substrate 10 but is applied above a further layer 42.

The further layer may have different functionalities. For example, the layer may have infrared reflective, electrochromic, thermochromic, magnetochromic, light scattering, light directing, or light emitting properties.

1-18. (canceled)

19. A product comprising:
a glass or glass-ceramic substrate; and
an inorganic layer at least partially provided on the substrate so that the layer has a surface that forms at least a portion of an outer surface of the product, the layer including a metal oxide and has an at least partially nanocrystalline structure, the layer comprising at least one metal oxide of an element selected from the group consisting of Hf, Y, Zr, and Ce as a basic material, wherein the layer further comprises at least one metal cation of an element selected from the group consisting of Ca, Ce, Y, K, Li, Mg, Sr, and Gd, and, due to the at least one further metal cation, provides a thermo-catalytic function.

20. The product as claimed in claim 19, wherein the layer further comprises a refractive index that ranges from 1.65 to 2.2; a low surface energy, with a polar fraction of less than 10 mN/m and a disperse fraction of less than 35 mN/m; a surface with a contact angle to water of greater than 80° such that the layer is hydrophobic; a residual porosity of less than 25 percent by volume; pores in a form of bottleneck-shaped mesopores or micropores, with an average pore diameter of less than 10 nm; a surface roughness of less than 10 nm; and a transmittance of more than 80% for electromagnetic radiation in a wavelength range from 380 nm to 1 mm.

21. The product as claimed in claim 19, wherein the at least one metal cation is present in a fraction up to 50 mol % of the content of the basic material.

22. The product as claimed in claim 19, wherein the basic material of the layer has a crystallite size from 4 to 50 nm.

23. The product as claimed in claim 19, wherein the nanocrystalline fraction in the layer is greater than 25 percent by volume.

24. The product as claimed in claim 19, wherein the nanocrystalline fraction in the layer is greater than 75 percent by volume.

25. The product as claimed in claim 19, wherein the layer comprises ZrO₂ as a basic material, and wherein the ZrO₂ is present in a form selected from the group consisting of a monoclinic crystal form, a tetragonal crystal form, and cubic crystal form.

26. The product as claimed in claim 19, wherein the layer comprises CeO₂as a basic material, and wherein the CeO₂ is present in a form selected from the group consisting of a monoclinic crystal form, a tetragonal crystal form, and cubic crystal form.

27. The product as claimed in claim 19, wherein the basic material is a Zr pyrochlore.

28. The product as claimed in claim 27, wherein the Zr pyrochlore is selected from the group consisting of Ce₂Zr₂O₇, La₂Zr₂O₇, Gd₂Zr₂O₇, and Y₂Zr₂O₇.

29. The product as claimed in claim 19, wherein the layer further comprises at least one components selected from the group consisting of Si, Al, Na, Li, Sr, B, P, Sb, Ti, F, MgF₂, and CaF₂.

30. The product as claimed in claim 19, wherein the layer further comprises, in addition to the basic material and to the at least one metal oxide, nanoparticles that are selected from the group consisting of inorganic nanoparticles, amorphous nanoparticles, and crystalline nanoparticles.

31. The product as claimed in claim 30, wherein the nanoparticles comprise oxidic nanoparticles having a diameter from 4 to 30 nm.

32. The product as claimed in claim 19, wherein the at least one metal oxide of the layer are embedded in a glassy matrix.

33. The product as claimed in claim 19, wherein the layer has a thickness of less than 80 nm.

34. The product as claimed in claim 19, wherein the substrate has at least one further metal oxide-containing layer onto which the inorganic layer is applied.

35. The product as claimed in claim 19, wherein the product is selected from the group consisting of a component in or on a device for cooking, frying, baking, or grilling, a radiation heated cooking device, a gas heated cooking device with, an induction heated cooking device, a microwave device, a deep fat frying device, a baking sheet, a baking mold, a cooking utensil, a component in or on a heat generating device in a fireplace or wood-burning stove, a component in or on a heating system, a radiant heating system, a radiant heater, an exhaust gas pipe, and exhaust air pipe, and a viewing window of a heating unit.

36. A method for producing a product, comprising:
providing an inorganic layer at least partially on a glass or glass-ceramic substrate, the layer including a metal oxide and has an at least partially nanocrystalline structure, the layer comprising at least one metal oxide of an element selected from the group consisting of Hf, Y, Zr, and Ce as a basic material, wherein the layer further comprises at least one metal cation of an element selected from the group consisting of Ca, Ce, Y, K, Li, Mg, Sr, and Gd, and, due to the at least one further metal cation, provides a thermo-catalytic function.

37. The method as claimed in claim 36, wherein the layer is produced by a liquid phase process comprising the steps of:
preparing a coating solution including metal salts and/or alkoxides;
applying the coating solution to the substrate, in a thickness of about 2 to 4 μm using a coating technique selected from the group consisting of roll coating, pad printing, spray coating, and preferably screen printing;
drying the metal oxide layer at temperatures around 200° C. to a layer thickness in a range from 200 to 400 nm; and
thermally post-treating the metal oxide layer at temperatures around 500° C.

38. The method as claimed in claim 36, wherein the layer is produced by a gas phase process comprising the steps of:
introducing the substrate into a heating chamber via a lock device;
introducing the substrate into a coating chamber; and
coating the substrate with the inorganic layer by sputtering from a target at a power density greater than 2 W/cm².
